(19) United States
(12) Patent Application Publication
(10) Pub. No.: US 2006/0171085 A1
(43) Pub. Date: Aug. 3, 2006

(54) Arc fault detection

(76) Inventor: Thomas Keating, Rockville Centre, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/330,632

(22) Filed: Jan. 12, 2006

Related U.S. Application Data
(60) Provisional application No. 60/646,139, filed on Jan. 21, 2005.

(51) Int. Cl. H02H 3/00

(52) U.S. Cl. 361/42

(57) ABSTRACT

An arc fault detector configured to process audio frequencies associated with an arc fault condition to detect the occurrence of an arc fault condition. In one embodiment, the arc fault detector includes an alternating current (AC) line filter for receiving an AC line signal having a line frequency portion and an audio frequency portion in the electromagnetic spectrum associated with at least one arc condition. The AC line filter removes the line frequency portion and passes the audio frequency portion to an audio frequency filter which processes the audio frequency portion for an arc fault signature to detect for the occurrence of an arc fault condition.

This application claims the benefit of U.S. provisional application having Ser. No. 60/646,139, which was filed Jan. 21, 2005.

### BACKGROUND OF THE INVENTION

1. Field of the Invention

The present invention relates to arc fault detection.

2. Description of the Prior Art

A typical arc fault circuit interrupter (AFCI) is connected between a power source and a load and includes an arc fault detector which can, in response to the detection of an electrical arc fault condition, cause the power source to be disconnected from the load. An arc fault condition can occur when current flows across a gap between conductors. It is important to provide arc fault protection because an arc fault often may generate a high temperature condition which can cause injury to people and/or damage to equipment. There are various techniques for detecting an arc fault condition such as analyzing some of the characteristics of an arc fault. For example, the light produced by an electrical arc between the contacts of a circuit breaker can be analyzed. Another technique involves analyzing changes or gaps in alternating current (AC) cycles of an AC line waveform during the occurrence of an arc fault.

However, these techniques may be unreliable and complex to implement. Therefore, there is a need to provide improved arc fault detection.

### SUMMARY OF THE INVENTION

The present invention overcomes some of the deficiencies of the prior art by providing techniques for detecting an electrical arc fault condition including analyzing the audio frequency portion of the electromagnetic spectrum (as opposed to radio frequency noise, high frequency noise, etc) of an arc fault. Because electrical arcing is associated with a characteristic noise pattern (such as a repetitive ticking sound), the technique of the present invention monitors the input AC line in the audible noise spectrum and removes or demodulates the effects of the 120 VAC, 60 Hz standard AC waveform. The technique then analyzes the remaining portion for indications of arcing by comparing the remaining portion to known arcing signatures. The technique employs an audio frequency filter network configured to detect an arc fault signature of an arc fault condition. An arc fault signature is defined as a unique audio frequency pattern or signature comprising one or more audio frequency components that comprise or accompany the occurrence of an arc fault condition. An arc fault condition is defined as the occurrence of electrical arcing across a gap of metal conductors as a result of current flowing through the conductors. For example, an arc fault signature is produced when electrical arcing occurs across a gap of copper conductors.

In one embodiment of the present invention, an arc fault detector includes an AC line filter and an audio frequency filter network coupled to the output of the AC line filter. The AC line filter receives an AC line signal having a line frequency portion and any audio frequency portion associated with the occurrence at least one arc fault condition. In a typical example, the AC line signal is a standard household 120/240 VAC power signal having a 50/60 Hz line frequency. The AC line filter removes the line frequency portion and passes the audio frequency portion to the audio frequency filter network which analyzes the audio frequency portion for an arc signature to detect an arc fault condition.

In another embodiment of the present invention, there is disclosed a method of detecting an arc condition by processing the audio frequency portion of an arc condition which can include comparing the audio frequency portion to an arc fault signature.

In another embodiment of the present invention, an arc fault circuit interrupter (AFCI) includes an arc fault detector which disconnects a power source from a load upon the detection of an arc fault condition.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiments as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 is a block diagram of an arc fault circuit interrupter (AFCI) having an arc fault detector according to an embodiment of the invention;

FIG. 2 is a flow chart of a method of detecting an arc fault according to an embodiment of the invention; and

FIG. 3 is a flow chart of a method of generating an arc fault condition and corresponding signature to an embodiment of the invention.

### DETAILED DESCRIPTION

The present invention provides an arc fault detection method and apparatus that includes analyzing the audio frequency portion of the electromagnetic spectrum (e.g., signals in the range from 200 Hz to 18 KHz more or less) that accompanies an arc fault condition. Because electrical arcing is associated with a characteristic noise pattern (such as a repetitive ticking sound), the technique of the present invention monitors the input AC line in the audible noise spectrum and removes or demodulates the effects of the 120 VAC, 60 Hz standard AC waveform. The technique then analyzes the remaining portion for indications of arcing by comparing the remaining portion to known arc fault signatures. The arc fault detector includes an audio frequency filter network configured to detect an arc fault signature of an arc fault condition. An arc fault signature is defined as a unique audio frequency signature or pattern comprising one or more audio frequency components that comprise or are associated with the occurrence of an arc fault condition. An arc fault condition is defined as the occurrence of electrical arcing across a gap of metal conductors. For example, a unique arc fault signature is produced when electrical arcing occurs across a gap of copper conductors.

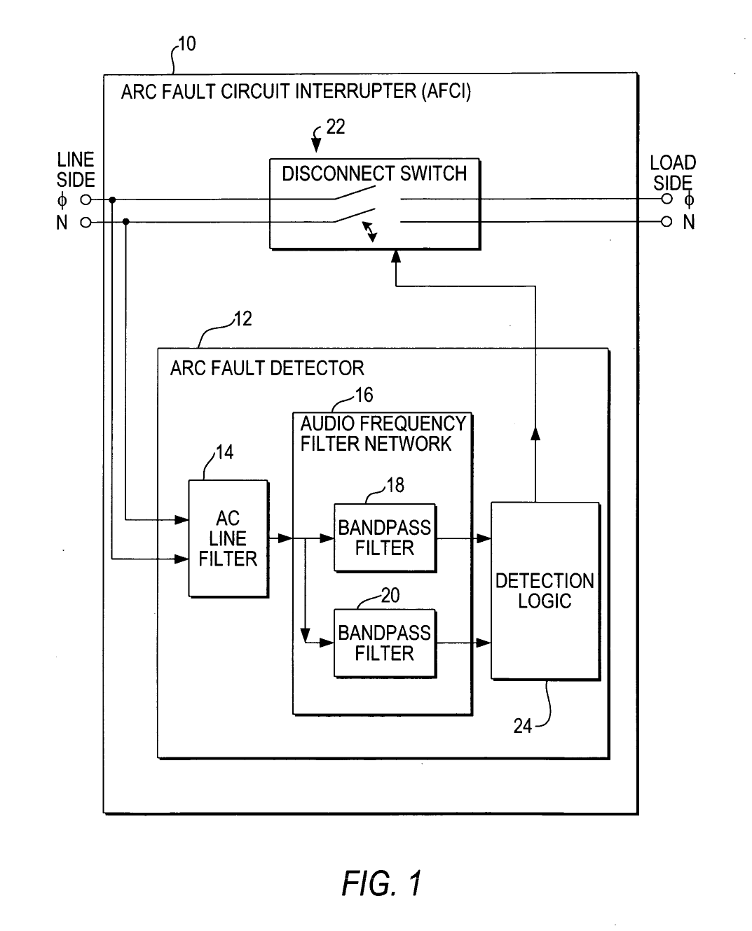

Referring to FIG. 1, shown is an arc fault circuit interrupter (AFCI) 10 incorporating an arc fault detector 12 according to an embodiment of the invention. The AFCI 10 has a resettable disconnect switch 22 to control a conductive path between a power source (not shown) via line side terminals and a load (not shown) via load side terminals. An example of a power source is a typical household power source of 120/240 Volts AC (VAC) having a line frequency of approximately 50/60 Hertz (Hz). The disconnect switch 22 can be an electromechanical switch (e.g., relay), a semiconductor switch (e.g., transistor) or other means for controlling the conductive path between the line and load side. The arc fault detector 12 has an input side connected to the line side terminals for receiving an AC signal from the power source and an output side coupled to the disconnect switch 22 to send a signal to the switch to control its operation. Upon the detection of an arc fault condition, the detector 12 sends a signal to the switch 22 to cause the switch to move to an open position (open contacts), as shown in FIG. 1, to disconnect the line side from the load side. This is referred to as “tripping” the AFCI. The AFCI can be reset by pressing a reset button (not shown) which causes the switch 22 to move to a closed position (closed contacts) which reconnects the line side to the load side.

The arc fault detector 12 includes an AC line filter 14 configured or tuned to filter out the line frequency portion of the AC power source and pass to an audio frequency filter network 16 any other remaining frequency portions of any other signals that may be present on the AC power source. The fault detector is configured to process the signals in the audio frequency portion of the electromagnetic spectrum associated with an arc fault condition. An example of a line filter is a notch filter having a center frequency around the 50 or 60 Hz frequency portion of the AC line power signal.

The audio frequency filter network 16 can be a broadband filtering network that includes one or more band pass audio filters 18, 20 each configured to pass a portion of the frequency portion which represents an arc fault signature associated with an arc fault condition. Each of the filters 18, 20 can be configured to have unique low and high cutoff frequencies to detect a frequency component of an arc fault signature associated with a particular arc fault condition. For example, suppose an electrical arc gap across copper conductors produces an arc fault condition with an arc fault signature comprising a first frequency component centered about 2 KHz and a second frequency component centered about 6 KHz. The first filter 18 is configured to have a low/high frequency cutoff to detect the 2 KHz signal and the second filter 20 is configured to have low/high frequency cutoff to detect the 6 KHz signal. The output of the audio frequency network 16 is processed by detection logic 24 which includes circuitry to compare the passed audio frequency portions to arc fault signatures. If there is a match, then the detection logic 24 generates a signal to the disconnect switch 22 to disconnect the line side terminal from the load side terminal.

Although the filter network 16 shows two filters it should be understood that the number of filters can vary depending on the number of audio frequency components which comprise an arc signature, the number of arc fault signatures desired to be detected or other factors. Other examples of electrical arcing signatures can be generated when electrical arcing occurs between metal conductors such as copper and copper conductors, copper and aluminum conductors, brass and aluminum conductors or other combinations. The AC line filter 14 and the filter network 16 can be implemented using well known analog and/or digital filtering techniques. The AFCI 10 including the disconnect switch 22 and other functions of an AFCI, but not the detector 12, are further described in U.S. Pat. No. 5,963,406, which is assigned to the assignee of the present invention, and is incorporated herein in its entirety by reference.

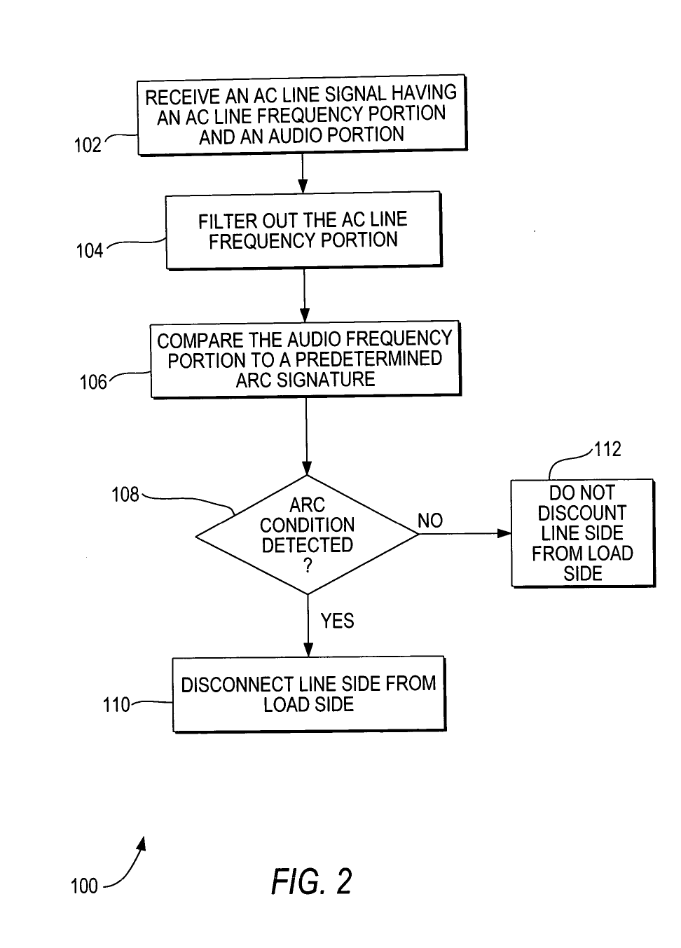

Referring to FIG. 2, there is shown a method 100 of detecting an arc fault condition. It is assumed that a user connects or installs an AFCI incorporating arc fault detecting techniques according to the present invention between a power source (AC signal) via the line terminals and a load via the load side terminals. Once the AFCI has been installed, processing proceeds to step 102 which includes receiving and monitoring the AC signal from the AC power source. The AC signal includes an AC line frequency (e.g., 60 Hz) and can include audio frequency portions in the electromagnetic spectrum which may be present during the occurrence of an arc fault condition. Next, in step 104, the AC line frequency portion (i.e., 60 Hz) is filtered out and any audio frequency portion associated with an arc fault condition is passed along to step 106 for further processing. In step 106, the audio frequency portion is compared to one or more arc fault condition signatures to determine whether an arc fault condition has occurred. In step 108, if the audio frequency portion matches an arc signature then an arc condition has been detected, the processing proceeds to step 110 which includes sending a signal to the disconnect switch to cause the load to be disconnected from the power source. On the other hand, if an arc fault condition is not detected, processing proceeds to step 112 where the disconnect switch is not operated and the load remains connected to the line and the processing of monitoring for arc condition continues. Thus, once an arc fault is detected, the load is disconnected from the line. It should be noted that the AFCI can be reset (i.e., the disconnect switch is moved back to the closed position) sometime after the arc condition has been investigated to allow the AFCI to continue to monitor for any further arc fault conditions.

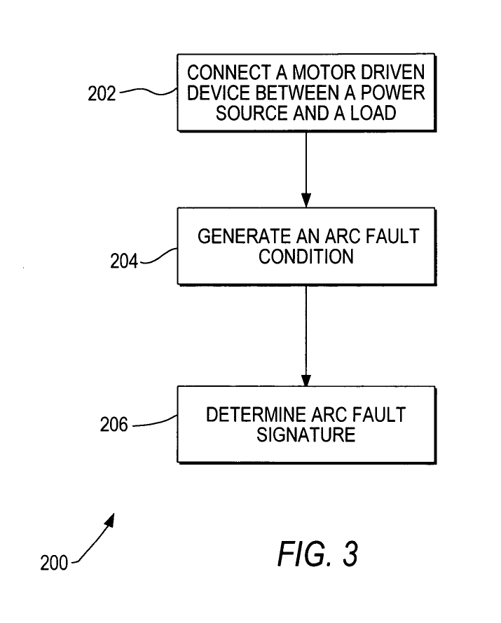

Referring to FIG. 3, there is shown a method 200 of generating an arc fault condition and corresponding arc fault signature. In a first step 202, an AC power source (e.g., 120 VAC, 60 Hz) is connected to a motor driven device having one fixed conducting electrode and one movable conducting electrode for causing an electrical arc. In step 204, the distance between the two electrodes can be varied to generate a continuous arc. The motor driven device is connected to produce an arc between the two conducting electrodes. The intensity of the arc is monitored by the circuitry so to provide conductive material(s) and/or metal(s) to generate a continuous arc. In step 206, the arc is analyzed and its arc fault signature determined. The signature is used by the arc fault detector of the present invention. This process can be used to generate additional arc fault conditions and corresponding arc fault signatures.

As explained above, the arc fault detector of the present can be incorporated in an AFCI to disconnect the AC power source from a load upon the detection of an arc fault. However, the techniques of the present invention can be equally applied to ground fault circuit interrupter (GFCI) devices or other circuit interrupter devices.

The techniques of the present invention may include one or more of the following advantages. For example, the reliability of arc fault detection can be improved by analyzing the audio frequency portion of the electromagnetic spectrum of an arc fault rather than analyzing the radio frequency noise, high frequency noise or other component of an arc fault condition as performed by the prior art. In addition, the present invention employs audio frequency detection techniques which are more immune to radio frequency (RF) interference than other techniques known in the art.

While there have been shown and described and pointed out the fundamental novel features of the invention as applied to the various embodiments, as is presently contemplated for carrying them out, it will be understood that various omissions and substitutions and changes of the form and details of the device illustrated and in its operation may be made by those skilled in the art, without departing from the spirit of the invention.

What is claimed is:

1. An arc fault detector comprising:
an alternating current (AC) line filter for receiving an AC line signal having a line frequency portion and an audio frequency portion associated with at least one arc condition where the filter is adapted to filter out the line frequency portion and pass the audio frequency portion;
an audio frequency filter coupled to the AC line filter to pass a portion of the audio frequency portion which represents an arc fault signature; and
a switch means coupled to the audio frequency filter to disconnect line terminal from load terminal when a signal which represents an arc fault signature is passed by the audio frequency filter.

2. The arc fault detector of claim 1 wherein the AC line filter is a notch filter having a center frequency around the line frequency.

3. The arc fault detector of claim 1 wherein the AC line signal is a 120/240 VAC power line signal having a line frequency of 50/60 Hertz.

4. The arc fault detector of claim 1 wherein the audio frequency portion is in the electromagnetic spectrum in the range approximately 200 Hz to 18 KHz.

5. The arc fault detector of claim 1 wherein the audio frequency filter comprises one or more bandpass filters each having a low and high audio range frequency cutoff corresponding to an arc fault signature corresponding to an arc fault condition.

6. A method of detecting an arc fault comprising:
receiving an AC line signal having a line frequency portion and an audio frequency portion associated with at least one arc fault condition;
removing the line frequency portion; and
processing the audio frequency portion to detect for the occurrence of an arc fault condition.

7. The method of claim 6 wherein processing the audio frequency portion includes comparing the audio frequency portion to an arc fault signature.

8. The method of claim 6 wherein the AC line signal is a 120/240 VAC power line signal having a line frequency of 50/60 Hertz.

9. The method of claim 6 wherein the audio frequency portion is in the electromagnetic spectrum in the range of approximately 200 Hz to 18 KHz.

10. The method of claim 6 further comprising disconnecting power from a load upon detection of an arc fault condition.

11. An arc fault circuit interrupter (AFCI) comprising:
a disconnect switch having a line side terminal for connection to a power source and a load side terminal for connection to a load; and
an arc fault detector configured to receive from the line side terminal an AC line signal having a line frequency portion and an audio frequency portion associated with at least one arc fault condition, wherein the arc fault detector removes the AC line frequency and process the audio frequency portion to detect the occurrence of an arc fault condition.

12. The AFCI of claim 11 wherein the arc fault detector includes an AC line filter to remove the AC line frequency.

13. The AFCI of claim 11 wherein the arc fault detector includes an audio frequency filter network to analyze the audio frequency portion for an arc fault signature to detect for the occurrence of an arc fault condition.

14. The AFCI of claim 11 wherein, upon the detection of an arc fault condition, the arc fault detector is further configured to send a signal to the disconnect switch to cause the line side to be disconnected from the load side.

15. The AFCI of claim 11 wherein the AC line signal is a 120/240 VAC power line signal having a line frequency of 50/60 Hertz.

16. The AFCI of claim 11 wherein the audio frequency portion in the electromagnetic spectrum is in the range of approximately 200 Hz to 18 KHz.
